(19) United States
(12) Patent Application Publication
(10) Pub. No.: US 2014/0053784 A1
(43) Pub. Date: Feb. 27, 2014

(54) PET LITTER CONTAINMENT CONSTRUCTION

(71) Applicant: Christine Auble, Foothill Ranch, CA (US)

(72) Inventor: Christine Auble, Foothill Ranch, CA (US)

(21) Appl. No.: 13/974,851

(22) Filed: Aug. 23, 2013

Related U.S. Application Data
(60) Provisional application No. 61/693,030, filed on Aug. 24, 2012.

(51) Int. Cl. A01K 1/01

(52) U.S. Cl. CPC A01K 1/0107
USPC 119/165

(57) ABSTRACT

A pet litter containment construction includes a lower compartment and an upper compartment. A litter box is located in an upper compartment. A ramp leads up to the upper compartment from the lower compartment. The ramp comprises a covering that encourages a separation of litter from claw, feet and/or legs of the pet. An entrance is positioned such that the animal traverses under the litter box to the ramp, up the ramp and into the litter box.

### CROSS-REFERENCE TO RELATED APPLICATIONS

Any and all priority claims identified in the Application Data Sheet, or any correction thereto, are hereby incorporated by reference under 37 CFR 1.57.

### BACKGROUND

1. Technical Field

The present application generally relates to waste devices used in animal husbandry. More particularly, certain aspects of the present invention relate to walled receptacles that can be used to contain animal litter.

2. Description of the Related Art

A variety of pet litter containers are known. For example, the following U.S. patents relate to pet liter containers: Nos. 3,885,523; 5,092,277; 5,329,879; 5,388,550; 5,806,461; 5,924,383; 6,412,440; 6,659,045; and 8,033,249. In addition, systems such as those shown in U.S. Pat. Publ. No. 2007/0234966 are known.

### SUMMARY

Unfortunately, while a variety of pet litter containers have been developed to contain pet litter and reduce the mess associated with pet litter, these pet litter containers suffer from a variety of drawbacks. For example, when an animal, such as a cat, has finished using the pet litter container, some of the pet litter inevitably sticks to the feet and legs of the animal. Thus, upon exiting the pet litter container, the litter is tracked into the surrounding areas.

In addition, the pet litter needs to be cleaned periodically. Removing the container that holds the pet litter often can be very difficult. Typically, the pet litter is located on a lower portion of any pet litter containment construction. This location is desired because of the weight associated with the pet litter; the lower location helps stabilize the construction. Cleaning the litter located in the lower position, however, demands stooping, bending and increases the difficulty with which the pet litter can be cleaned.

Certain features, aspects and advantages of the present invention address one or more of these problems.

In one aspect, an animal litter containment construction comprises a lower floor defining a lower plane. A litter container has a bottom surface, a plurality of sidewalls, and a doorway in one or more of the plurality of sidewalls, with the bottom surface of the litter container lying on an upper plane. The upper plane is substantially parallel to and above the lower plane. A ramp spans at least a portion of a vertical distance between the lower plane and the upper plane. The ramp is covered with a removable and washable material configured to encourage the removal of litter from the feet and claws of the animal. The doorway in the litter container has a lower threshold that is located above the upper plane and the animal litter containment construction is configured to fit within a household cabinet.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 is a front perspective view of an outside of a pet litter containment construction that is arranged and configured in accordance with certain features, aspects and advantages of the present invention;

FIG. 2 is a front perspective view of an inside of the construction of FIG. 1.

FIG. 3 is a rear perspective view of a box used in the construction of FIG. 1.

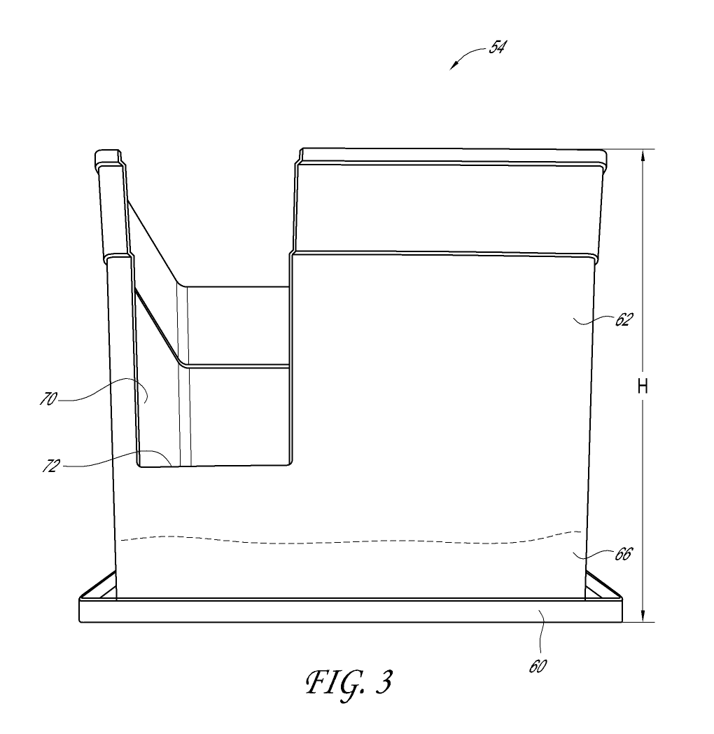

FIG. 4 is a top front perspective view of an inside of the construction of FIG. 1 with the box removed.

### DETAILED DESCRIPTION

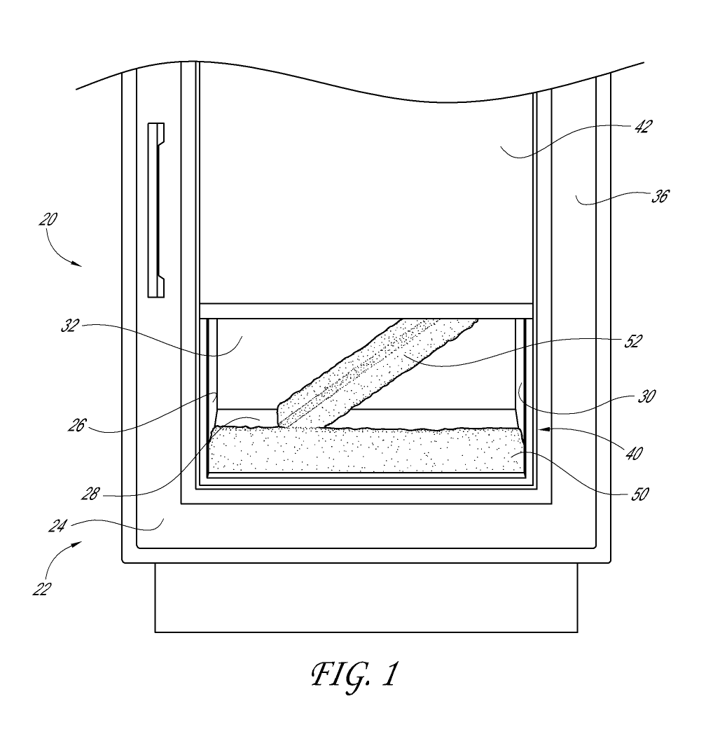

FIG. 1 illustrates a pet litter containment construction 20 that has been arranged and configured in accordance with certain features. As illustrated, the pet litter containment construction 20 can comprise, or be positioned within, an external cabinet 22. The external cabinet 22 can have any suitable configuration and provides an aesthetically pleasing outer appearance for the pet litter containment construction 20.

The illustrated external cabinet 22 preferably comprises at least one door 24. The door 24 can be connected to the external cabinet in any suitable manner. For example, the door 24 can be connected to another portion of the cabinet with hinges or the like. The illustrated external cabinet 22 comprises a first side wall 26 and a second side wall 30. In addition, the illustrated external cabinet 22 comprises a rear wall 32. The external cabinet 22 can have a lower floor 28. The lower floor 28 can be bound on three sides by the first side wall 26, the rear wall 32, and the second side wall 30.

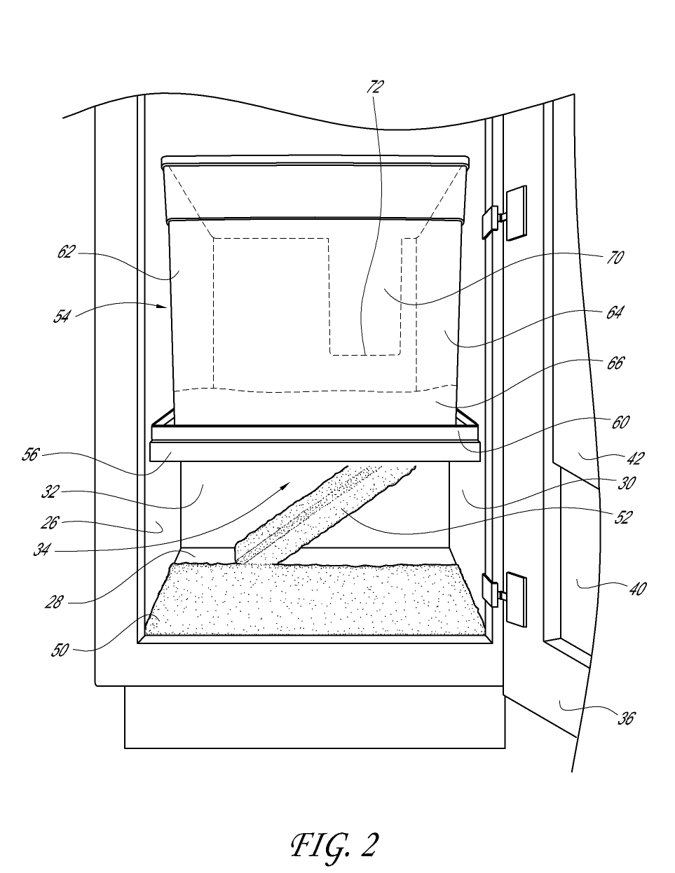

As illustrated in FIG. 2, cavity 34 can be defined between the first side wall 26 and the second side wall 30. The door 24 preferably covers a portion of the cavity 34. In some embodiments, the opening is approximately eighteen inches wide. In some configurations, the opening is between about twenty two inches wide and about twenty six inches wide. In some embodiments, the external cabinet 22 is about twenty four inches wide and about twenty four inches deep. Other sizes also are possible keeping in mind the desire to move a litter container in and out of the cavity 34.

Advantageously, by having the door 24 cover a majority of the opening 40, internal components of the pet litter containment construction 20 need not have finished edges because the edges are concealed during normal use. In the illustrated configuration, the door 24 comprises an outer perimeter 36 that generally covers an outer extreme of the cavity 34. A door opening 40 can be defined inwardly of the outer perimeter 36. In the illustrated configuration, a panel 42 is generally encircled by the outer perimeter 36. The panel 42 has a height that is less than an inner height between a top and bottom of the outer perimeter 36. As such, the door opening 40 generally is defined in part by the outer perimeter 36 and in part by the panel 42. In some configurations, the door opening can be defined entirely by the panel 42. The door opening provides access into the cavity 34. The door opening preferably is positioned in a lower half of the door 24. More preferably, the opening extends over at least a portion of a lower quarter of the door 24. Even more preferably, the opening does not extend upward beyond a shelf 56 or any higher than a lower surface of the shelf 56. In some configurations, the opening 40 does not extend any higher than a lower portion of the litter box. In some configurations, the opening 40 only extends upward to a position that does not overlap at least one of the litter box and the support structure for the litter box. In some embodiments, the door opening 40 can include one or more hinged covers (e.g., similar to a pet door) that effectively hide the inside of the external cabinet 22 while allowing an animal to enter the cabinet.

With reference now to FIG. 2, the pet litter containment construction comprises an entrance pad 50, a ramp 52, and a litter box 54 that is positioned generally vertically above the entrance pad 50. In the illustrated configuration, the litter box 54 is supported by the shelf 56. In some embodiments, the litter box 54 can be supported by two or more rails along the first side wall 26 and the second side wall 30. In some applications, the litter box 54 can be supported by one or more member that extends between any two or more of the walls 26, 30, 32. Furthermore, in some applications, one or more pegs or other support structures can be used to support the shelf 56 and/or the litter box 54. For example, the pegs can extend outward from the shelf 56 and engage structures in the adjacent walls and/or the pegs can extend from the adjacent walls to engage the shelf 56. The pegs can be positioned at variable heights to accommodate installation of the shelf 56 and/or the litter box into different outer cabinets 22.

The entrance pad 50 extends from a forward portion of a lower floor 28 rearward toward a rearward portion of the lower floor 28. In some embodiments, the entrance pad 50 extends the entire distance from the forward end of the lower floor 28 to the rear wall 32. In some such embodiments, the entrance pad 50 includes one or more cut out portions to accommodate the bottom of the ramp 52. In some configurations, the entrance pad 50 extends from forward end of the lower floor 28 rearward to a point short of the rear wall 32. In the illustrated configuration, the entrance pad 50 extends from the first side wall 26 to the second side wall 30. In other configurations, the entrance pad 50 may span only a portion of the distance between the first side wall 26 and the second side wall 30. By spanning substantially the full distance, the entrance pad 50 is more likely to be traversed when the animal passes between the ramp 52 and the door opening 40. Moreover, by spanning substantially the full distance, the entrance pad 50 can provide an enlarged resting area should the animal decide to seek the seclusion of the pad 50.

The entrance pad 50 can be formed of any suitable material. In the illustrated configuration, the entrance pad 50 comprises a high pile carpet or the like. Other materials can be used to form a surface over which the animal will pass. For example, the material can be patio turf, low pile carpet, a polymeric surface with adhesive (e.g., a sticky mat similar to those used for basketball shoes), or any other appropriate material, for example but without limitation. In some embodiments, the material used for the entrance pad 50 is waterproof or at least water-resistant.

The ramp 52 is proximate the rear wall 32 of the illustrated construction. The ramp 52 extends from the lower surface to the shelf 56. Preferably, the ramp 52 has a width of about six inches. In some configurations, the width is between about 8 inches and about ten inches. The length of the ramp 51 can be such that it does not extend the full width of the inner cabinet width when inclined to provide passage from an upper level to a lower level in the construction. The ramp can be a separate component from the rest of the construction 20 or can be connected to one or more of the shelf 56, the litter box 54, and the lower floor 28.

The ramp 52 preferably is covered with a surface that will encourage the removal of litter from the feet and claws of the animal. In particular, it has been found that moving down the ramp 52, when covered with an appropriate material, causes the claws to extend and encourages the removal of litter from the feet and claws. In some configurations, the material is a deep pile carpet. In other configurations, for example but without limitation, the material can be patio turf, low pile carpet, a polymeric surface with adhesive (e.g., a sticky mat similar to those used for basketball shoes), or any other appropriate material, for example but without limitation. The surface material on the ramp 52 can, in some configurations, be waterproof or at least water resistant. In some embodiments, a waterproof or water-resistant pad is used under the surface material for the ramp 52.

Preferably, the material used to cover the ramp 52 and/or for the entrance pad 50 can be removable from the containment construction 20 without the need to remove the ramp 52 and/or the lower floor 28. For example, ramp 52 and/or for the entrance pad 50 can have hook and loop fasteners or some other suitable arrangement that can be used to secure the material to the ramp 52 and/or for the entrance pad 50. In some embodiments, the material used to cover the ramp 52 and/or for the entrance pad 50 is removable from the containment construction 20 and is washable. In some configurations, the ramp cover can wrap around the ramp 52 and be secured to the bottom of the ramp 52. For example, the ends of the cover can be secured together with hook and loop fasteners, for example but without limitation, or can be secured to the ramp (e.g., the bottom surface of the ramp) using hook and loop fasteners, for example but without limitation.

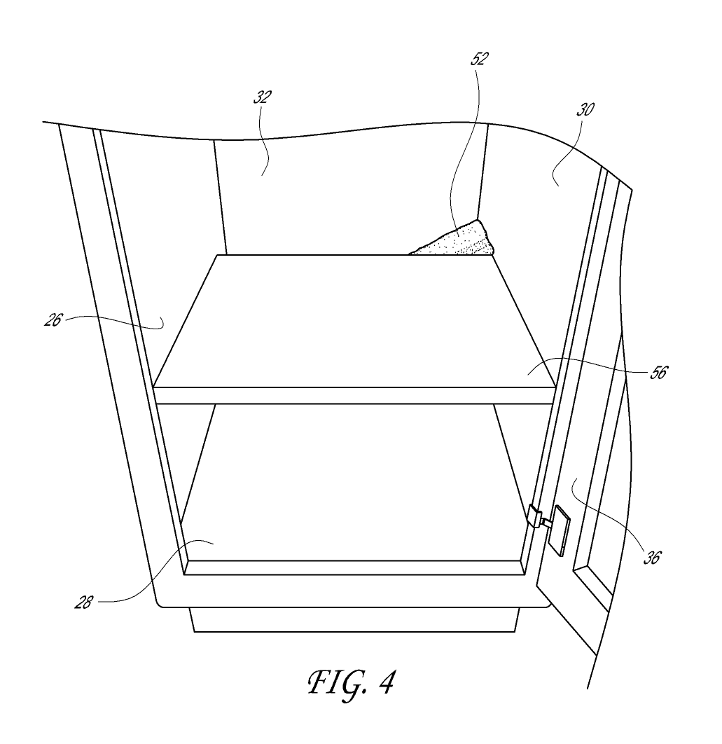

As illustrated in FIG. 4, the shelf 56 can have a depth that is shallower than the lower floor 28. As such, an opening between a lower compartment and an upper compartment can be defined. The opening allows the animal to move along the ramp 52 between the upper compartment and the lower compartment. The ramp 52 can be configured to allow space for a landing adjacent the litter box 54. For example, the top of the ramp 52 can be spaced at a distance from both the first and second side walls 28, 32 to allow for a platform connected to the top of the ramp and one of the first side wall 28 and the second side wall 32. In some embodiments, as described above, the litter box 54 is supported by two or more rails, pins, cross members or the like and, in some such embodiments, the litter box can be shallower than the lower floor 28, allowing the animal to move along the ramp between the upper compartment and the lower compartment.

The shelf 56 supports any suitable litter box 54. In the illustrated configuration, the litter box 54 comprises an underlying pan 60 that is slightly larger than a bottom surface of a box 62 that rests atop the pan 60. The pan 60 can be sized and configured to form a lid to the box 62 when the box 62 is not in use. Preferably, however, the pan 60 is slightly oversized relative to the bottom of the box 62 such that litter that drops from the animal upon exit from the box 62 can be caught by the pan 60. In some embodiments, the pan 60 is shallower than the lower floor 28.

The illustrated box 62 has high side walls 64. Other box configurations can be used. The high side walls 64 of the illustrated box reduce the likelihood of litter or spray escaping the inside of the box 62. The box 62 can contain litter 66 in use. Because the box 62 is supported above the entrance pad 50, the box 62 is more easily removed for cleaning of the litter. In some configurations, the shelf 56 can be a sliding shelf such that the shelf 56 and the box 62 can be slid outward of the upper cavity for removal and/or cleaning.

Preferably, at least one of the high sidewalls 64 of the box 62 comprises a doorway 70. The doorway 70 allows entrance into and exit from the inside of the box 62. The illustrated doorway 70 comprises a lower threshold 72 that is sufficiently high to reduce the likelihood of the litter 66 spilling from the inside of the box 62. In some configurations, the threshold 72 is about six inches above the bottom of the box 62. In other configurations, the threshold 72 can be between about two inches and about eight inches above the bottom of the box 62.

In some arrangements, the high sidewalls 64 of the box 62 have a height H that is about fourteen inches. In some arrangements, the height H is between about nine inches and about eighteen inches. The height H can be about one inch less than the distance between the top of the shelf 56 and the top inner surface of the outer cabinet 22. In some arrangements, the height H can be between about one half of an inch and 3 inches less than the distance between the top of the shelf 56 and the top inner surface of the outer cabinet 22. In some embodiments, the distance height H is about one inch less than a distance between the top of the shelf 56 and the bottom of an upper section of the cavity 34. By having a relatively small distance between the top inner surface of the outer cabinet 22 and the top of the shelf 56, the likelihood of materials passing out from the inside of the box is minimized.

While the illustrated configuration has been described within reference to the outer cabinet 22 and some of the illustrated components are components of that cabinet 22, it is possible to configure the construction 20 to be an insert that easily slides into a cavity of a standard kitchen or bathroom cabinet. Moreover, in some configurations, the construction 20 can be a stand-alone structure as opposed to being insertable into the cabinet 22. In such stand-alone configurations, the construction 20 preferably comprises the door 24, the first side wall 26, the second side wall 30 and the rear wall 32. Moreover, in configurations with a front wall instead of the door 24, for example but without limitation, the top can remain open or be provided with a door for access to the litter box 54.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

1. An animal litter containment construction, the construction comprising;
a lower floor defining a lower plane;
a litter container having a bottom surface, a plurality of sidewalls, and a doorway in one or more of the plurality of sidewalls, the bottom surface of the litter container lying on an upper plane, the upper plane being substantially parallel to and above the lower plane;
a ramp spanning the vertical distance between the lower plane and the upper plane, the ramp covered with a removable and washable material configured to encourage the removal of litter from the feet and claws of the animal;
wherein the doorway has a lower threshold that is located above the upper plane and the animal litter containment construction is configured to fit within a household cabinet.

2. The animal litter containment construction of claim 1, further comprising an upper floor having an upper surface, the upper surface lying on the upper plane

3. The animal litter containment construction of claim 2, wherein the litter container is positioned upon the upper floor.

4. The animal litter containment construction of claim 1, wherein the litter container is removable from the construction.

5. The animal litter containment construction of claim 1, wherein the removable and washable material is patio turf

6. The animal litter containment construction of claim 1, wherein the removable and washable material is low pile carpet.

7. The animal litter containment construction of claim 1, wherein the removable and washable material is a polymeric surface with adhesive.

8. The animal litter containment construction of claim 1, wherein the removable and washable material is high pile carpet.

9. The animal litter containment construction of claim 1, wherein the lower floor is covered with a removable and washable material.

10. The animal litter containment construction of claim 9, wherein the lower floor is positioned between the ramp and a door of a household cabinet when the animal litter containment construction is fit into a household cabinet.

11. The animal litter containment construction of claim 1, further comprising a pan, wherein the litter container sits in and upon the pan.
